(19) United States
(12) Patent Application Publication
(10) Pub. No.: US 2007/0024083 A1
(43) Pub. Date: Feb. 1, 2007

(54) Vehicle drop door

(75) Inventor: Jerry G. Ryman, Nappanee, IN (US)

Correspondence Address: BARNES & THORNBURG LLP, 11 SOUTH MERIDIAN, INDIANAPOLIS, IN, 46204, US

(73) Assignee: Met'afraun Incorporated

(21) Appl. No.: 11/194,880

(22) Filed: Aug. 1, 2005

(51) Int. Cl. B60J 5/00

(52) U.S. Cl. 296/146.1

(57) ABSTRACT

A vehicle door generally includes a drop door capable of covering an opening in a vehicle body and a drop door formed to include an access doorway having an access door. The vehicle may be self-propelled or towed, as in the case of a trailer. The drop door can move relative to the vehicle body between a opened position uncovering its opening and a closed position covering the opening. The access door can move between an open and closed position to allow access to the vehicle interior without opening the drop door.

### BACKGROUND

The present disclosure relates to vehicle doors. More particularly, the present disclosure relates to vehicle doors within doors.

Vehicle doors are used to allow access to an interior portion of a vehicle. A door within a vehicle door may be desirable when, for example, spatial constraints prevent the vehicle door from being opened, or to limit the escape of conditioned air from a vehicle interior, or for ease of ingress and egress, and/or security from or into the interior portion of the vehicle

### SUMMARY

The present disclosure may comprise one or more of the following features recited in the attached claims, and/or one or more of the following features and combinations thereof. A vehicle generally includes a vehicle body and a drop door formed to include an access doorway having an access door. The vehicle may be self-propelled or towed, as in the case of a trailer. The drop door can move relative to the vehicle body between an opened position uncovering an opening formed in a portion of the vehicle body and a closed position covering the opening. The opening may be formed in an end or a side of the vehicle. The drop door is used to allow access to an interior portion of the vehicle body. The drop door may provide a user with a sloping surface or ramp when the drop door is in the opened-ramp position to provide a user with assistance in loading or unloading items from the interior portion of the vehicle body.

The drop door is formed to include a doorway. The access door is moveable from a closed position covering the doorway and an opened position allowing access to the interior through the doorway. The access door may include a hinged portion to couple the access door to the drop door and to allow the access door to pivot so that the access door can be moved from an opened-door position uncovering the doorway to a closed-door position covering the doorway.

The access door may be configured in a variety of ways. In one illustrative example, it takes the form of a sliding door coupled to the drop door and configured to slide along an edge surface of the drop door to close the doorway. In another illustrative example, the drop door may include two hinged door portions arranged in side-by-side relation configured so that the door portions pivot toward one another to close the doorway. In still another illustrative example, the access door includes a “two-way” hinge to allow the access door to pivot from the interior portion of the vehicle body when the drop door is in the closed position to close the doorway, or to pivot from an exterior portion of the vehicle body when the drop door is in the closed-ramp position to close the doorway.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of an illustrative vehicle drop door, with portions broken away, in accordance with the present disclosure showing a vehicle including the drop door hinged to the vehicle at one end in an up position covering an opening to block access to the vehicle interior, and an access door coupled to the drop door to allow access to the interior of the vehicle when the drop door is in the up position;

FIG. 2 is a perspective view of the vehicle drop door of FIG. 1, with portions broken away, showing the vehicle access door moving from a closed-door position to an opened-door position to uncover the doorway to allow access to the interior;

FIG. 3 is a perspective view of the vehicle drop door of FIG. 1, with portions broken away, showing the drop door in a down position to allow access to the vehicle interior and the vehicle access door in the closed-door position;

FIG. 4 is a perspective view of the vehicle drop door of FIG. 1, with portions broken away, showing the drop door in the down position to allow access to the vehicle interior and the vehicle access door moving in an opened position;

FIG. 5 is an elevation view of the vehicle drop door of FIGS. 1-4 showing the drop door in the up position to block access to the vehicle interior and the vehicle access door coupled to the ramp to cover the doorway;

FIG. 6A is a sectional view taken generally along lines 6-6 of FIG. 5, with portions broken away, showing a second illustrative vehicle access door configured to slide in relation to the drop door to allow access to the vehicle interior when the drop door is in the up position;

FIG. 6B is a sectional view taken generally along lines 6-6 of FIG. 5, with portions broken away, showing a third illustrative vehicle access door configured having a pair of hinged “double” doors configured to pivot independently toward the interior of the vehicle, or to allow each door to pivot away from the interior of the vehicle to allow access to the vehicle interior when the drop door is in the up position; and

FIG. 6C is a sectional view taken generally along lines 6-6 of FIG. 5, with portions broken away, showing a fourth illustrative vehicle access door having a hinged “swinging” door configured to pivot toward the interior of the vehicle, or to pivot away from the interior of the vehicle, to allow access to the vehicle interior when the drop door is in the up position.

### DETAILED DESCRIPTION

For the purposes of promoting an understanding of the principles of the disclosure, reference will now be made to one or more illustrative embodiments illustrated in the drawings and specific language will be used to describe the same.

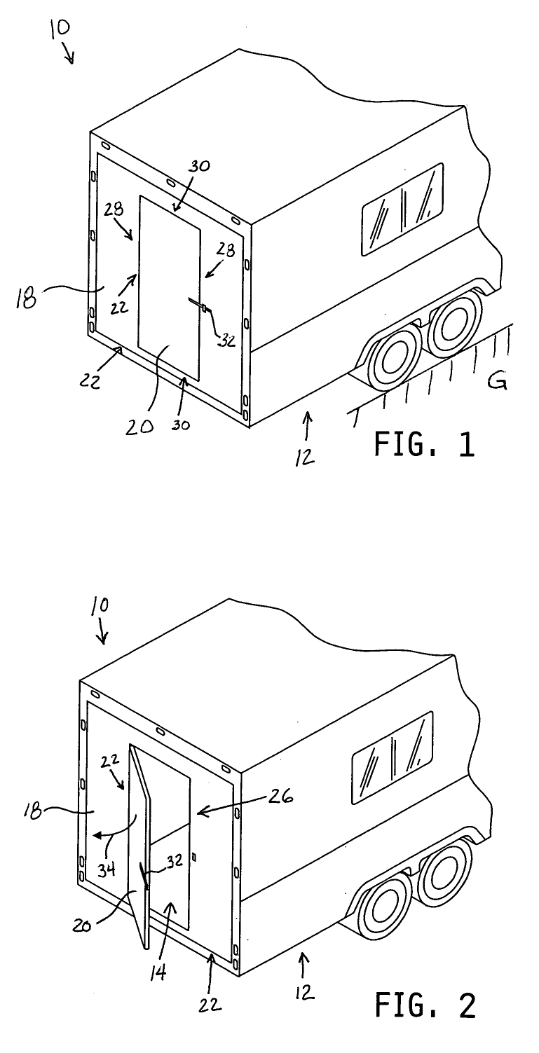

A vehicle door 10 assembly is configured to allow access to an enclosed vehicle 12, as shown, for example, in FIG. 1. Illustratively, the vehicle door assembly, or vehicle door 10, includes a drop door 18 and an access door 20 or doors 20 coupled to the drop door 18. The vehicle door 10 may be a drop door 18 while the illustrative opening 16 is in one and of the vehicle, it may be found at the other end or in one of the sides of the vehicle. The vehicle 12 may be self-propelled or towed, as in the case of a trailer. Illustratively, the drop door 18 is configured as a ramp 18 that slopes from the vehicle down to the ground. The access door 20 allows a user to gain access to the interior region 14 without having to open, or when, for example, it is not possible to open the drop door 18 because of spatial limitations inhibiting the opening of the drop door 18, or to prevent the escape of conditioned air from the interior region 14.

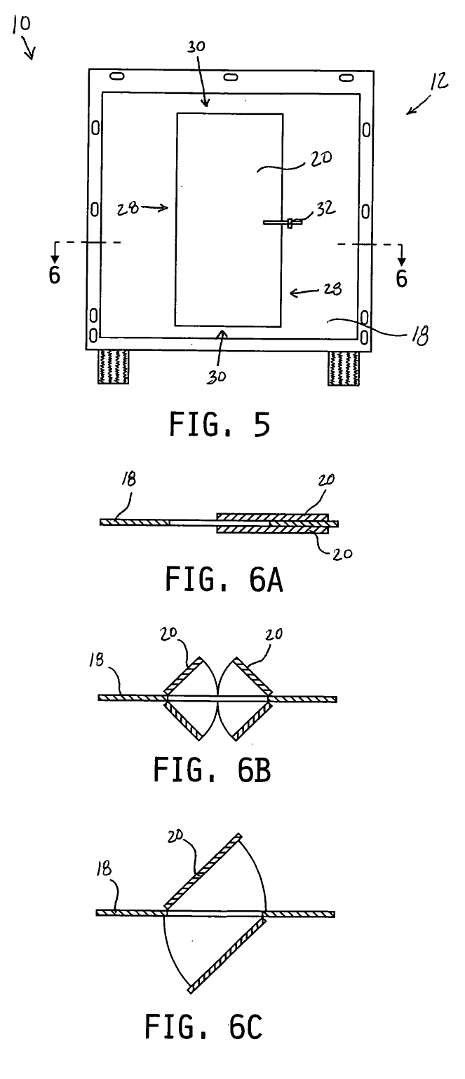

The vehicle 12 may be arranged to receive therein and transport, for example, vehicles, or other equipment. Illustratively, the interior region 14 of the vehicle 12 is arranged in spaced apart relation to a ground surface G, as shown in FIGS. 1-5. The drop door 18 is configured to move relative to the vehicle 12 between an opened or down position uncovering the opening 16 and a closed or up position covering the opening 16. The drop door 18 is moveably coupled to the vehicle body 12 by use of, for example, a hinge 22 for movement relative to the vehicle 12 generally about an axis 24 between the down and up positions.

Illustratively, the opening 16 and the drop door 18 are generally, but need not be, rectangular, as shown, for example, in FIGS. 1-5. The drop door 18 may be arranged, for example, by a user so that the drop door 18 provides a sloped surface that slopes generally downwardly from the vehicle to the ground surface G to assist the user in loading or unloading equipment, or, for example, to drive a vehicle into the interior region 14.

The drop door 18 illustratively is formed to include a doorway 26, as shown, for example, in FIG. 2. The doorway 26 provides the user with access to the interior region 14 without moving the drop door 18 from the up position covering the opening 16 to the down position uncovering the opening 16. The access door 20 is arranged to be coupled to the drop door 18 for movement relative to the drop door 18 between an opened position uncovering the doorway 26 and a closed position covering the doorway 26. Illustratively, the doorway 26 and associated access door 20 or doors 20 are not coextensive with the drop door 18.

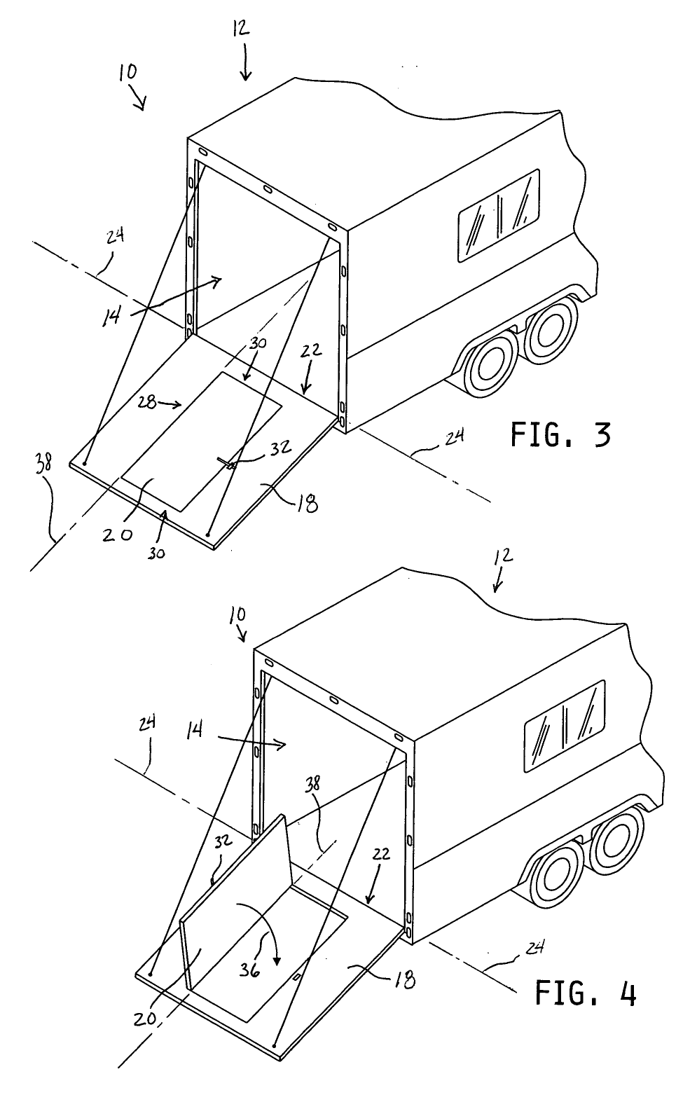

Illustratively, the access door 20 includes two parallel longer sides 28 and two parallel shorter sides 30 shorter than longer sides 28, and a lock 32, as shown best in FIGS. 1 and 3. Illustratively, the access door 20 is coupled to the drop door 18 by use of a hinge 22 along one of the longer sides 28 for movement relative to the drop door 18 about a pivot axis 38. The axis 38 illustratively is arranged to be generally perpendicular to the pivot axis 24.

In some embodiments, the access door 20 may be configured to pivot relative to the drop door 18 about the pivot axis 38 and away from the interior region 14 in a direction 34 to move toward the opened position uncovering the doorway 26. In other embodiments, the access door 20 may be configured to pivot relative to the drop door 18 inwardly toward the interior region 14 in a direction 36 to move toward the open position uncovering the doorway 26. In still other embodiments, the access door 20 may be configured to pivot relative to the drop door 18 either toward the interior region 14 or away from the interior region 14 to move toward the opened position uncovering the doorway 26.

The access door 20 may also be configured to be coupled to the drop door 18 for slidable movement relative to the drop door 18 between an opened position uncovering doorway 26 and a closed position covering doorway 26. In other embodiments contemplated by this disclosure, the access door 20 may be arranged as a sectional access door 20 coupled to an interior portion of the drop door 18 and configured for slidable movement on guide rails (not shown) between the opened position uncovering the doorway 26 and the closed position covering the doorway 26. The sectional access door 20 may also be configured to open by slidably moving the sectional access door 20 upward to a storage position above the doorway 26, or alternatively, by slidably moving the sectional door 20 downward to a storage position below the doorway 26.

In still other embodiments contemplated by this disclosure, the access door 20 may be configured having two “swinging” door panels arranged in a side-by-side configuration. The door panels 20 are coupled to the drop door 18 for pivotable movement into the interior region 14 or away from the interior region 14, as shown in FIG. 6B. It will also be appreciated that the access door 20 may be coupled at its bottom edge to the drop door 18 such that the access door 20 opens in a downwardly sloping relationship toward the ground surface G.

The lock 32 is configured to lock the access door 20 relative to the drop door 18. The lock 32 may comprise any suitable locking means, including, for example and without limitation, a bolt, a hasp, a lug, or any combination thereof. Illustratively, upon movement of the lock 32 to the locked position, the access door 20 is generally co-planar with the drop door 18 and forms a usable portion of the sloped surface of the drop door 18. The lock 32 may further include a number of locking members for securely locking the access door 20 to the drop door 18. When the access door 20 is locked relative to the drop door 18, its doors 18, 20 move generally in unison and relative to the vehicle 12 between the up and down positions.

Means for accessing the interior region without moving the drop door 18 to the opened position may include the access door 20 cooperating with the doorway 26 formed in the drop door 18 to provide an entry or exit way. The access door 20 may include a segmented panel door, a sliding door, or any other door suitable for covering and uncovering the doorway 26. The access door 20 may be constructed of metal, wood, laminate, plastics, or any other generally rigid material suitable for use as a door. The drop door 18 and/or its access door(s) 20 may have any suitable shape, including square, rectangular or other polygonal shape, circular, oval, ellipsoidal, triangular, etc.

Although illustrated in use with a vehicle drop door 18, the vehicle access door 20 may be used in any application where a door within a door configuration is used. While the disclosure has been illustrated and described in detail in the foregoing drawings and description, the same is to be considered illustrative and not restrictive in character, it being understood that only illustrative embodiments thereof have been shown and described and that all changes and modifications that come within the spirit of the disclosure are desired to be protected.

1. A vehicle comprising
a vehicle body formed to include an interior region and an opening into the interior region,
a drop door arranged to move relative to the vehicle body between a down position uncovering the opening and an up position covering the opening, the drop door defining an access doorway through a portion of the drop door, and
an access door arranged to move relative to the vehicle body between an opened position uncovering the access doorway and a closed position covering the access doorway.

2. The vehicle of claim 1, wherein the access door and drop door may move in unison relative to the vehicle to uncover the opening.

3. The vehicle of claim 2, wherein the drop door includes an upper edge and a lower edge lower than the upper edge, the lower edge of the drop door configured to be moveably coupled to the vehicle body at the lower edge of the opening.

4. The vehicle of claim 2, wherein the access door may move independently of and relative to the drop door to uncover the access doorway.

5. The vehicle of claim 4, wherein the interior region is higher than a ground surface and the drop door is arranged to provide a sloped surface between the interior region and the ground surface when the drop door is in the down position.

6. The vehicle of claim 1, wherein the access door includes two longer sides and two shorter sides shorter than the longer sides, and the access door is coupled to the drop door along one of the longer sides for movement relative to the drop door.

7. The vehicle of claim 6, wherein the access door is configured to move relative to the drop door into the interior region.

8. The vehicle of claim 6, wherein the access door is configured to move relative to the drop door away from the interior region.

9. The vehicle of claim 1, further comprising a door lock for locking the access door from movement relative to the drop door.

10. The vehicle of claim 9, wherein the access door is configured for sliding movement relative to the drop door between the opened position uncovering the access doorway and the closed position covering the access doorway.

11. The vehicle of claim 9, wherein the access door includes a first door panel and a second door panel, the door panels arranged in a side-by-side relationship, each door panel coupled to the drop door for movement away from one another relative to the drop door.

12. The vehicle of claim 9, wherein the access door is configured to move relative to the drop door both into and away from the interior region when the drop door is in the up position.

13. A vehicle door comprising
a drop door configured to couple to a vehicle body for movement into the vehicle body relative to the vehicle body between a down position uncovering an opening and an up position covering the opening, the drop door formed to include an access doorway, and
an access door coupled to the drop door and configured to move relative to the drop door between an opened position uncovering the access doorway and a closed position covering the access doorway.

14. The vehicle door of claim 13, wherein the access door is configured to move about a horizontal door axis away from the vehicle body.

15. The vehicle door of claim 14, wherein the access door is configured to be substantially co-planar with the drop door when the access door is moved to the closed position.

16. The vehicle door of claim 13, further comprising a lock configured to lock together the access door in the closed position and the drop door.

17. The vehicle door of claim 16, wherein the access door is configured to slide relative to the drop door between the opened position and the closed position.

18. A vehicle comprising
a vehicle body formed to include an interior region and an opening into the interior region,
a drop door arranged to move relative to the vehicle body between an opened position uncovering the opening and a closed position covering the opening, and
means formed in the drop door for accessing the interior region of the vehicle without moving the drop door to the down position so that a user can gain access into the interior region of the vehicle.

19. The vehicle access door of claim 18, wherein the drop door is a drop door coupled on a bottom edge to the vehicle body for movement away from the interior region to uncover the opening.

20. A method of allowing access into a vehicle interior through a drop door, the method comprising
providing an access door formed in the drop door to cover a doorway,
and moving the access door to uncover the access doorway.
